(19) United States
(12) Patent Application Publication
(10) Pub. No.: US 2012/0170191 A1
(43) Pub. Date: Jul. 5, 2012

(54) Midplane With A Direct Connect Adapter

(75) Inventors: David J. Jensen, Raleigh, NC (US); Pravin S. Patel, Cary, NC (US); Derek I. Schmidt, Raleigh, NC (US); Brian A. Trumbo, Apex, NC (US)

(73) Assignee: INTERNATIONAL BUSINESS MACHINES CORPORATION, Armonk, NY (US)

(21) Appl. No.: 12/981,668

(22) Filed: Dec. 30, 2010

(51) Int. Cl. H01R 12/00; G06F 1/16

(52) U.S. Cl. 361/679.02; 439/65

(57) ABSTRACT

A midplane that includes a direct connect adapter mounted within the midplane, the direct connect adapter including: a first opening for receiving a first computing component connector on a first side of the midplane; and a second opening for receiving a second computing component connector on a second side of the midplane, and the direct connect adapter mounted within the midplane electrically coupling the first computing component connector and the second computing component connector without electrically coupling the first computing component connector and the second computing component connector to the midplane.

### BACKGROUND OF THE INVENTION

1. Field of the Invention

The field of the invention is data processing, or, more specifically, apparatus and products for a midplane with a direct connect adapter.

2. Description of Related Art

Modern computing systems have become increasingly complex. Such modern computing systems may include a variety of components, including components that operate as fully functional computers. Connecting such computing components may be accomplished using backplanes, midplanes, or other printed circuit boards that carry electrical signals between computing components. As such printed circuit boards become more complex, however, the impedance that is experienced when carrying electrical signals between computing components increases. As such, the impedance that is experienced when carrying electrical signals between computing components differs in large part based on the physical characteristics of the particular printed circuit boards that carries electrical signals between computing components.

### SUMMARY OF THE INVENTION

A midplane that includes a direct connect adapter mounted within the midplane, the direct connect adapter including: a first opening for receiving a first computing component connector on a first side of the midplane; and a second opening for receiving a second computing component connector on a second side of the midplane, and the direct connect adapter mounted within the midplane electrically coupling the first computing component connector and the second computing component connector without electrically coupling the first computing component connector and the second computing component connector to the midplane.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a midplane with a direct connect adapter according to embodiments of the present invention.

FIG. 2 sets forth a block diagram of a midplane with a direct connect adapter according to embodiments of the present invention.

FIG. 3 sets forth a block diagram of a computing component rack according to embodiments of the present invention.

### DETAILED DESCRIPTION OF EXEMPLARY EMBODIMENTS

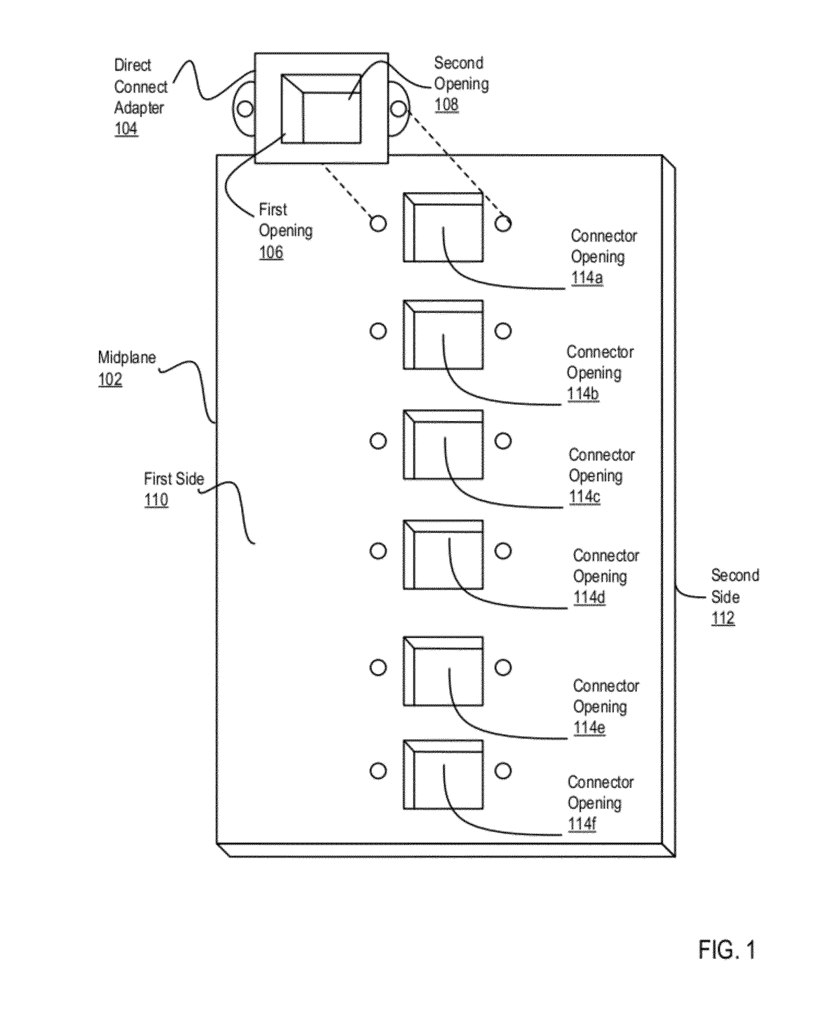

Exemplary apparatus and products for a midplane with a direct connect adapter in accordance with the present invention are described with reference to the accompanying drawings, beginning with FIG. 1. FIG. 1 sets forth a block diagram of a midplane (102) with a direct connect adapter (104) according to embodiments of the present invention. In the example of FIG. 1, the midplane (102) is a structure useful in providing electrical connectivity to computing devices on both sides of the midplane (102). In the example of FIG. 1, the midplane (102) can provide electrical connections to computing devices on the first side (110) of the midplane (102). In addition, the midplane (102) can also provide electrical connections to computing devices on the second side (112) of the midplane (102).

In the example of FIG. 1, the midplane (102) may be embodied as a printed circuit board. In the example of FIG. 1, such a midplane (102) can include conductive pathways, such as tracks or signal traces, that are used to electrically connect computing devices that are connected to the midplane (102). In the example of FIG. 1, such a midplane may also include conductive vias capable of connecting computing devices. A conductive via may be embodied, for example, as one or more holes punched through the midplane (102). The conductive vias may include a conductive material along the walls of the opening for transferring an electric signal between connector pins of the computing devices that are inserted into the connective vias. In such an example, a first computing device may have connector pins inserted into the conductive vias on a first side (110) of the midplane (102) and a second computing device may have connector pins inserted in the conductive vias on a second side (112) of the midplane (102).

In the example of FIG. 1, the midplane (102) may alternatively be embodied a sheet metal structure. In such an example, the midplane (102) itself does not include any signal carrying components on the surfaces of the midplane (102). In such an example, electrical connectivity between two or more computing devices is carried out exclusively by a direct connect adapter (104) mounted a connector opening (114a-114f) within the midplane (102).

In the example of FIG. 1, the midplane (102) includes a direct connect adapter (104) mounted within the midplane (102). In the example of FIG. 1, the direct connect adapter (104) is mounted within the midplane (102) via a connector opening (114a-114f). A connector opening (114a-114f) is an opening, such as a hole, in the midplane (102) itself. In the example of FIG. 1, the direct connect adapter (104) may be mounted within the midplane (102), for example, by inserting the direct connect adapter (104) into a connector opening (114a-114f) of the midplane (102). In the example of FIG. 1, the direct connect adapter (104) may be mounted to the midplane (102) in a fixed configuration where the direct connect adapter (104) is affixed within the midplane (102) such that the direct connect adapter (104) may not be moved relative to the midplane (102). Alternatively, the direct connect adapter (104) may be mounted to the midplane (102) in a floating configuration where the direct connect adapter (104) is affixed within the midplane (102) such that the direct connect adapter (104) may be moved relative to the midplane (102). For example, the direct connect adapter (104) may be affixed within the midplane (102) using a shoulder screw that enables the direct connect adapter (104) to move relative to the midplane (102). Likewise, the direct connect adapter (104) may be affixed within the midplane (102) using a slidable mount that enables the direct connect adapter (104) to move relative to the midplane (102). In the example of FIG. 1, the direct connect adapter (104) may be made out of a non-conductive material such as plastic such that there is no electrical coupling between the direct connect adapter (104) and the midplane (102).

In the example of FIG. 1, the direct connect adapter (104) includes a first opening (106) for receiving a first computing component connector on a first side (110) of the midplane (102). In the example of FIG. 1, the direct connect adapter (104) includes a second opening (108) for receiving a second computing component connector on a second side (112) of the midplane (102). Each opening (106, 108) is located on parallel surfaces of the midplane (102) such as, for example, the front and back of the midplane (102). In the example of FIG. 1, each opening (106, 108) is configured to receive computing component connector. In the example of FIG. 1, a computing component connector is a conductive device for electrically joining computing components together. The computing component connector may be embodied, for example, as an edge connector on a printed circuit board, as a cable connected to a computing device, as pins of an adapter, and so on.

In the example of FIG. 1, the direct connect adapter (104) that is mounted within the midplane (102) electrically couples the first computing component connector and the second computing component connector without electrically coupling the first computing component connector and the second computing component connector to the midplane (102). The direct connect adapter (104) may be constructed of a non-conductive material such as, for example, a plastic material. As such, the direct connect adapter (104) of FIG. 1 would not be electrically coupled to the midplane (102) and would not provide an electrical coupling between the first computing component connector and the second computing component connector via the midplane (102).

In the example of FIG. 1, the direct connect adapter (104) may include conductive paths for electrically connecting the first computing component connector and the second computing component connector. For example, the direct connect adapter (104) may include conductive paths such as cooper traces that run from the first opening (106) in the direct connect adapter (104) to the second opening (108) in the direct connect adapter (104). Each computing component connector may have pins or other connector components that come into direct physical contact with such conductive paths in the direct connect adapter (104) when the computing component connectors are inserted into the direct connect adapter (104). In such an example, the physical properties of the conductive paths are known, such as the particular material that forms the conductive path, the length of the conductive path, and so on. Because the physical properties of the conductive paths are known, the electrical impedance encountered on the conductive paths is also known. As such, the electrical impedance that exists between the first computing component connector and the second computing component connector is constant and in no way dependent upon the physical properties of the midplane (102).

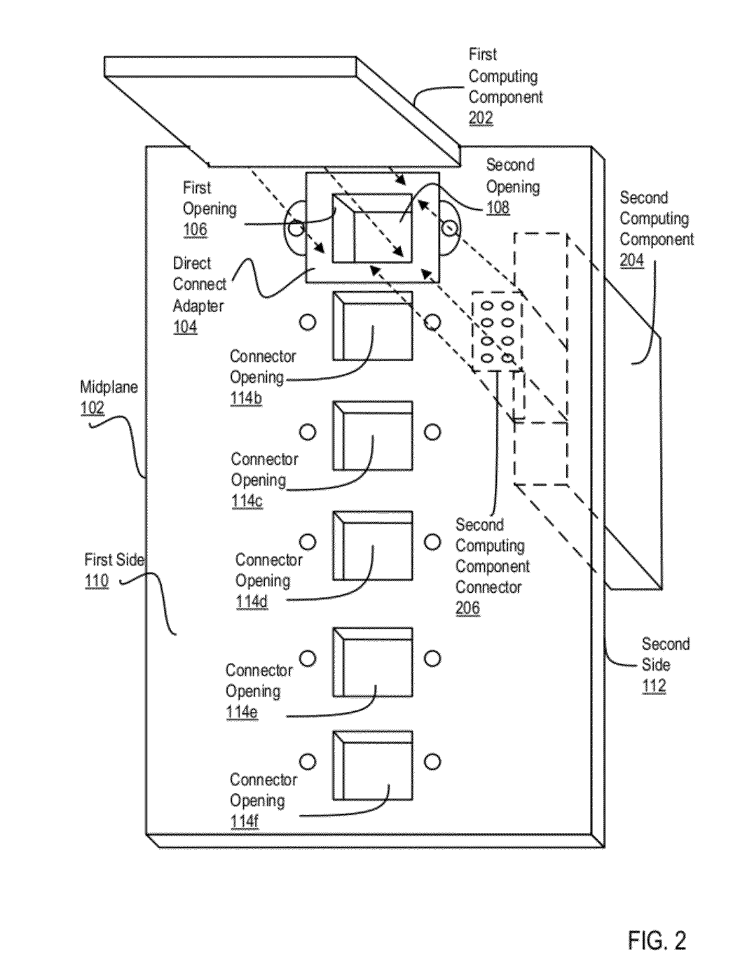

For further explanation, FIG. 2 sets forth a block diagram of a midplane (102) with a direct connect adapter (104) according to embodiments of the present invention. The midplane (102) of FIG. 2 is similar to the midplane (102) of FIG. 1 as it also includes connector openings (114b-114f), a front side (110) of the midplane (102), and a second side (112) of the midplane (102). In the example of FIG. 2, the direct connect adapter (104) is mounted within the midplane (102). The direct connect adapter (104) of FIG. 2 is similar to the direct connect adapter (104) of FIG. 1 as it also includes a first opening (106) on the first side (110) of the midplane (102) and a second opening (108) on the second side (112) of the midplane (102). In the example of FIG. 2, a first computing component (202) and a second computing component (204) are illustrated. Each computing component (202, 204) includes a computing component connector, although only the computing component connector (206) of the second computing component (204) is illustrated in FIG. 2.

In the example of FIG. 2, the computing component connector of the first computing component (202) may be inserted into the first opening (106) of the direct connect adapter (104) and the second computing component connector (206) of the second computing component connector (206) of the second computing component (204) may be inserted into the second opening (108) of the direct connect adapter (104) such that the first computing component (202) and the second computing component (204) are electrically coupled. In the example of FIG. 2, each computing component (202, 204) may be similar computing components or different computing components capable of data communications with each other. For example, the first computing component (202) may be a blade server while the second computing component (204) is a switch for routing data communications to and from the blade server. In such an example, the first computing component connector is a connector of a blade server such as, for example, a network interface controller for the blade server, and the second computing component connector (206) is a connector for the switch.

In the example of FIG. 2, the first computing component connector is orthogonally mounted relative to the second computing component connector (206). In the example of FIG. 2, the first computing component connector is orthogonally mounted relative to the second computing component connector (206) as the first computing component (202) is mounted horizontally while the second computing component (204) is mounted vertically. Such orthogonally mounted computing components may be embodied, for example, as a horizontally mounted expansion card installed on the first side (110) of the midplane (102) and a vertically mounted expansion card mounted on the second side (112) of the midplane (102), such that expansion cards mate orthogonally.

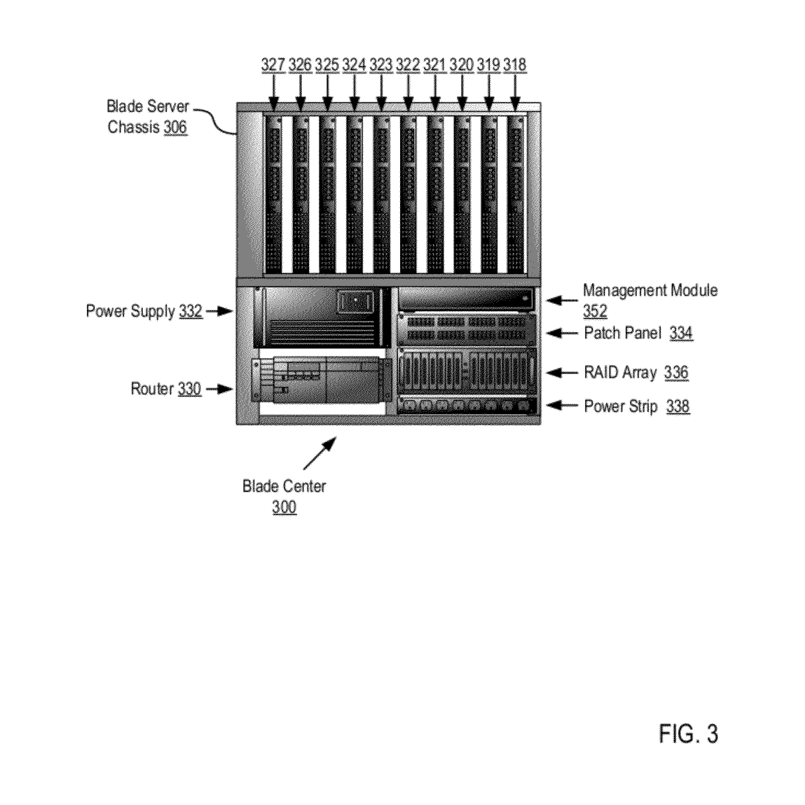

For further explanation, FIG. 3 sets forth a block diagram of a computing component rack according to embodiments of the present invention. In the example of FIG. 3, the computing component rack is embodied as a blade center that includes a plurality of computing components. Blade centers (300) capable of being configured according to embodiments of the present invention include the Blade System from HP, the BladeCenter from IBM®, and others as will occur to those of skill in the art.

The blade center (300) in the example of FIG. 3 includes a blade server chassis (306) housing a number of blade servers (318-327). Blade servers (318-327) are installed in blade server chassis (306). A blade server chassis is an enclosure in which blade servers as well as other electrical components are installed. The chassis provides cooling for servers, data communications networking connections, input/output device connections, power connections, and so on as will occur to those of skill in the art. One example blade server chassis is IBM's BladeCenter. An IBM BladeCenter E includes 14 blade slots, a shared media tray with an optical drive, floppy drive, and Universal Serial Bus (‘USB’) port, one or more management modules, two or more power supplies, two redundant high speed blowers, two slots for Gigabit Ethernet switches, and two slots for optional switch or pass-through modules such as Ethernet, Fibre Channel, InfiniBand or Myrient 2000 modules. A server, as the term is used in this specification, refers generally to a multi-user computer that provides a service (e.g. database access, file transfer, remote access) or resources (e.g. file space) over a network connection. The term ‘server,’ as context requires, refers inclusively to the server's computer hardware as well as any server application software or operating system software running on the server. A server application is an application program that accepts connections in order to service requests from users by sending back responses. A server application can run on the same computer as the client application using it, or a server application can accept connections through a computer network. Examples of server applications include file server, database server, backup server, print server, mail server, web server, FTP servers, application servers, VPN servers, DHCP servers, DNS servers, WINS servers, logon servers, security servers, domain controllers, backup domain controllers, proxy servers, firewalls, and so on.

Blade servers are self-contained servers, designed for high density. As a practical matter, all computers are implemented with electrical components requiring power that produces heat. Components such as processors, memory, hard drives, power supplies, storage and network connections, keyboards, video components, a mouse, and so on, merely support the basic computing function, yet they all add bulk, heat, complexity, and moving parts that are more prone to failure than solid-state components. In the blade paradigm, most of these functions are removed from the blade computer, being either provided by the blade server chassis (DC power) virtualized (iSCSI storage, remote console over IP), or discarded entirely (serial ports). The blade itself becomes simpler, smaller, and amenable to dense installation with many blade servers in a single blade server chassis.

In addition to the blade servers (309-327), the blade server chassis (306) in the example of FIG. 3 also house several other electrical components including a power supply (332), a data communications router (330), a patch panel (334) a RAID array (336), a power strip (338) and a management module (352).

A management module is an aggregation of computer hardware and software that is installed in a data center to provide support services for computing devices, such as blade servers. Support services provided by the management module (352) include monitoring health of computing devices and reporting health statistics to a system management server, power management and power control, save and restore configurations, discovery of available computing devices, event log management, memory management, and so on. An example of a management module that can be adapted for use in systems for securing blade servers according to embodiments of the present invention is IBM's Advanced Management Module (‘AMM’).

In the example of FIG. 3, the blade center (306) can include a midplane (not shown) as described above. In the example of FIG. 3, the midplane may be positioned approximately in the middle of the blade server chassis (306). Such a midplane may include a direct connect adapter mounted within the midplane as described above. The direct connect adapter may include a first opening for receiving a first computing component connector on a first side of the midplane and a second opening for receiving a second computing component connector on a second side of the midplane. The direct connect adapter mounted within the midplane can electrically couple the first computing component connector and the second computing component connector without electrically coupling the first computing component connector and the second computing component connector to the midplane.

The arrangement of servers, chassis, routers, power supplies, management modules, and other devices making up the exemplary system illustrated in FIG. 3 are for explanation, not for limitation. Data processing systems useful according to various embodiments of the present invention may include additional servers, routers, other devices, and peer-to-peer architectures, not shown in FIG. 3, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 3.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A midplane comprising:
a direct connect adapter mounted within the midplane, the direct connect adapter including:
a first opening for receiving a first computing component connector on a first side of the midplane; and
a second opening for receiving a second computing component connector on a second side of the midplane, and
the direct connect adapter mounted within the midplane electrically coupling the first computing component connector and the second computing component connector without electrically coupling the first computing component connector and the second computing component connector to the midplane.

2. The midplane of claim 1 wherein the midplane comprises a printed circuit board.

3. The midplane of claim 1 wherein the midplane comprises a sheet metal structure.

4. The midplane of claim 1 wherein first computing component connector comprises a connector of a blade server and the second computing component connector comprises a connector of a switch.

5. The midplane of claim 1 wherein the first computing component comprising the first computing component connector is orthogonally mounted relative to the second computing component comprising the second computing component connector.

6. A direct connect adapter comprising:
a nonconductive frame for mounting the direct connect adapter within a midplane;
a first opening for receiving a first computing component connector on a first side of the midplane;
a second opening for receiving a second computing component connector on a second side of the midplane; and
conductive paths for electrically coupling the first computing component connector with the second computing component connector without electrically coupling the first computing component connector and the second computing component connector to the midplane.

7. The direct connect adapter of claim 6 wherein the first opening is configured to receive a connector of a blade server and the second opening is configured to receive a connector of a switch.

8. The direct connect adapter of claim 6 wherein the first computing component comprising the first computing component connector is orthogonally mounted relative to the second computing component comprising the second computing component connector.

9. A computing component rack comprising:
one or more computing components;
a midplane; and
a direct connect adapter mounted within the midplane, the direct connect adapter including:
a first opening for receiving a first computing component connector on a first side of the midplane; and
a second opening for receiving a second computing component connector on a second side of the midplane, and
the direct connect adapter mounted within the midplane electrically coupling the first computing component connector and the second computing component connector without electrically coupling the first computing component connector and the second computing component connector to the midplane.

10. The computing component rack of claim 9 wherein the midplane comprises a printed circuit board.

11. The computing component rack of claim 9 wherein the midplane comprises a sheet metal structure.

12. The computing component rack of claim 9 further comprising a switch, wherein first computing component connector comprises a connector of one of the blade servers and the second computing component connector comprises a connector of the switch.

13. The computing component rack of claim 9 wherein the first computing component comprising the first computing component connector is orthogonally mounted relative to the second computing component comprising the second computing component connector.
